(19) United States
(12) Patent Application Publication
(10) Pub. No.: US 2014/0326795 A1
(43) Pub. Date: Nov. 6, 2014

(54) Training Room and Use Thereof

(71) Applicant: Vincent LECLERC, Paris (FR)

(72) Inventor: Vincent Leclerc, Paris (FR)

(21) Appl. No.: 14/357,536

(22) PCT Filed: Nov. 9, 2012
(86) PCT No.: PCT/FR2012/000450

§ 371 Date: May 9, 2014

(30) Foreign Application Priority Data
Nov. 9, 2011 (FR) 1103410

(51) Int. Cl. E04H 3/14; F24D 19/10; H05B 3/00; F24F 11/00

(52) U.S. Cl. CPC E04H 3/14; F24F 11/0008; F24D 19/1096; H05B 3/008
USPC 236/1 C; 392/416

(57) ABSTRACT

A training gym is a closed windowless room provided with at least one access door, and infrared heater, a humidistat for regulating the ambient humidity in said indoor space; lighting; and at least one vent. In use the training gym is maintained at a temperature of at least about 37° C. and a relative humidity of 50 to 60% to promote increased effectiveness of exercise and optimum benefit of a training session for physical and sports training, fitness, functional rehabilitation, and post-traumatic or post-operative reathletization for athletes at beginner, experienced or expert levels (elite athletes) making use of the training gym.

The present invention relates to facilities for physical exercises in training rooms. It relates more particularly to a training facility allowing changes to the conditions for performing physical exercises, functional rehabilitation and what is known professionally as “reathletization”, with or without sports equipment, in order to achieve improved results while reducing the risk of injury to muscles, ligaments or tendons.

The invention relates more specifically to a module constituting an enclosed volume, here known as a training room, for attaining such objectives.

Generally all sorts of physical exercises and other sports activities, with or without sports equipment, are performed either in training rooms where the ambient temperature is around 20° C./22° C., or outdoors.

According to the activity practiced, the result to be achieved is attained within an allocated time. Said result can consist of an individual or team performance, or simply the completion of a program, most frequently divided into sequences, relating to training or physical rehabilitation and/or reathletization.

The challenge faced in all cases for the attainment of satisfactory results is either:
achieving this result while significantly reducing the allocated time;
significantly improving the result while keeping within the same allocated time.

By “result”, is meant here without distinction the performances sought, weight loss, improved musculature, rebalancing the absolute or relative muscle tone of the lower and/ or upper limbs, etc.

According to the invention, a facility has now been designed that provides training means suitable for solving this problem.

The invention thus relates firstly to a facility consisting of a module suitable for constituting a training room, with or without sports equipment for physical exercises, in which said module is presented in the form of a training room defining an enclosed indoor space, said training room comprising a combination of:
a windowless closed room, provided with at least one access door;
means for heating said indoor space by infrared radiation, advantageously adjustable by a thermostat;
means for regulating the ambient humidity in said indoor space;
means for lighting said indoor space, preferably with a dimmer switch; and
at least one device for ventilating said indoor space.

In advantageous embodiments and alternative variants, the device according to the invention can comprise optional features that can be taken into consideration separately or in combination, such as in particular those in which the module comprises:

partitions made from or clad in strips of wood; a ceiling made from strips of wood; an inner floor constituted by a flexible and shock-absorbent covering; a humidifier, and advantageously a device for ionizing the indoor air (known as an air ionizer);

a variable lighting system with manual control or controlled according to a recorded program; a command and control panel; a ventilation system via at least one ventilation vent; a carbon monoxide detector; and/or at least one mirror, and items of equipment for convenience or entertainment such as in particular: a CD and/or DVD player, a radio set, an MP3 player, a television screen or a video monitor, etc.

Advantageously, the regulation means according to the invention are designed and arranged to be capable of raising the indoor temperature of the training room to 45° C., and even to 60° C., and preferably of maintaining the temperature at approximately 37° C. and the humidity of the air between approximately 50 and 60% inside said training room.

The invention will be better understood, and other aims, advantages and features thereof will become more clearly apparent in the light of the detailed description hereinafter of embodiments of the invention.

These embodiments are furnished purely for the purposes of illustration and are in no way limitative, while drawings are attached to the present description in which:

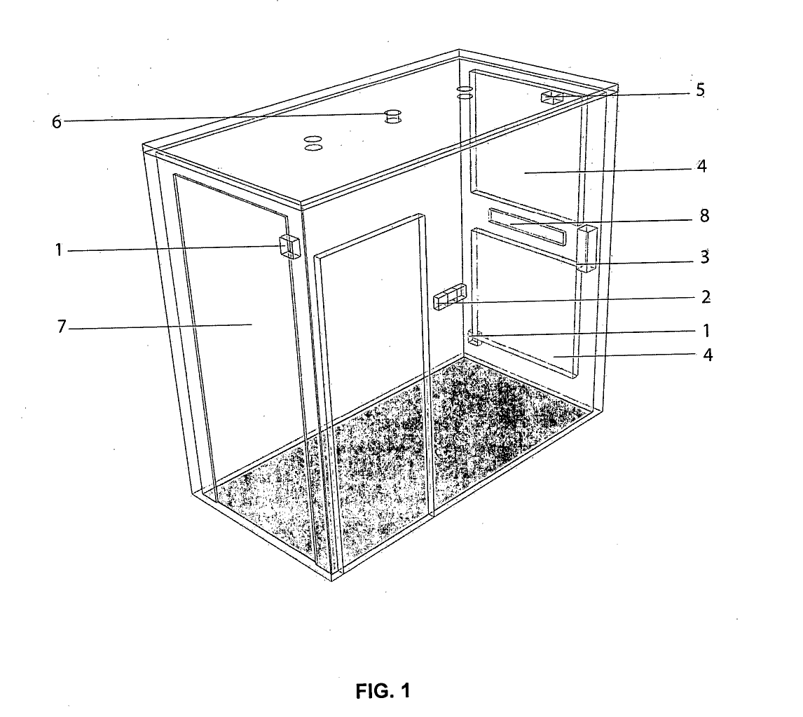

FIG. 1 shows diagrammatically a schematic perspective view of a training room module according to the invention, in the absence of additional sports equipment; and

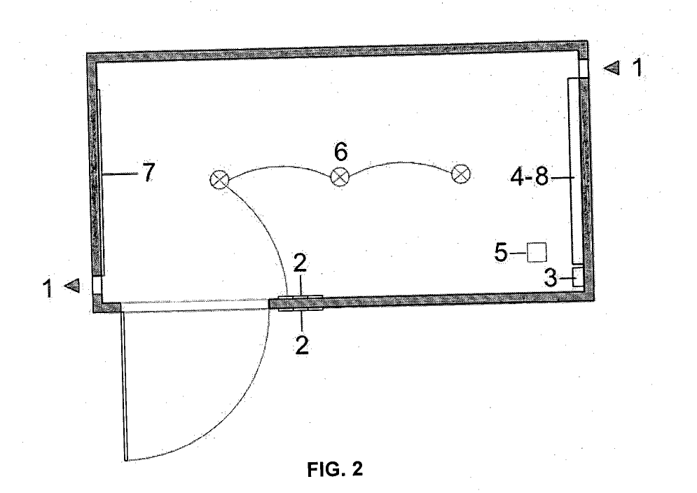

FIG. 2 shows an elevation top view of the training room module according to FIG. 1, through a ceiling that is assumed to be transparent in order to allow the interior elements of equipment according to the invention to be located.

With reference to the drawings thus briefly described that illustrate the invention without limiting it in any way, the present invention is described in greater detail hereinafter.

The training room according to the invention can have a parallelepipedic shape, on the basis of a rectangular ground plan as shown in FIGS. 1 and 2. It can also adopt any other shape that may be suitable for applications or specific space requirements, for example with a circular, hexagonal ground plan or other.

The dimensions thereof can be chosen for convenience, such as for example a length of approximately 2.60 m, a width of approximately 1.30 m and a height of approximately 2.20 m.

With the geometrical shapes that make this possible, combinations/juxtapositions of training rooms are also possible, even advantageous in order to allow space saving.

In the case of a plurality of n users of one and the same module forming a training room, where n is an integer equal to, or greater than 2, it is recommended, non-limitatively, to give said training room module ground plan dimensions representing approximately between n and 2/3 n times the base dimensions for one person.

The nomenclature of the elements (necessary or simply optional elements, as applicable) appearing in the drawings of the training room shown is as follows:
1 air vent,
2 command/control panel (thermostat and/or humidistat),
3 air humidifier/ionizer,
4 radiant infrared panels,
5 carbon monoxide detector,
6 variable intensity lamps,
7 mirror,
8 CD or DVD player, radio, MP3 player, monitor, television screen, or other accessories.

A training room according to the invention thus consists of a windowless enclosed volume provided with at least one access door, comprising at least one air vent 1, infrared heating, for example by radiant panels 4 (two in number in FIG. 1), an air humidifier 3 advantageously with humidistat, also preferably having the function of ionizer, at least one lamp 6, and optionally a command/control panel 2, a carbon monoxide detector 5, as well as, if desired, various accessories chosen for convenience, such as for example a mirror 7 and/ or a CD or DVD player, a radio set, an MP3 player, a television screen or video monitor, among others, all referenced symbolically as 8.

The number of infrared radiators is not limited and they can be placed on one or more of the walls, or even on or in the ceiling.

A subject of the invention is also the use of a training room such as described above, for providing training means to one or more persons having need thereof.

In advantageous embodiments, the use of the training room module according to the invention comprises:

adjusting the temperature inside the training room module to approximately 37° C., while the infrared heating means are designed and arranged to be capable of raising the temperature inside said training room to 45° C., and even advantageously to 60° C.,

adjusting the humidity level in the training room module between approximately 50% and 60%, preferably to approximately 55%. The humidistat 3 allows measurement of the humidity of the air inside said training room and acts on the air conditioning installation in order to maintain this humidity.

In fact, in its most advantageous form of use, the training room according to the invention is heated and kept at a temperature of approximately 37° C. with a humidity level comprised between approximately 50 and 60%.

Such a training room equipped with these functionalities has particularly remarkable attributes for the physical activities which can be performed therein. In fact, the ambient temperature of 37° C., combined with the exercises practiced therein, increases the body temperature from the start of the training, thus promoting:
increased effectiveness of the exercise and optimum benefit from the training session (intensity of movement/frequency of workout) giving a higher-quality result compared with that of a similar training session carried out under the usual thermal conditions (i.e. at 20° C./22° C. approximately) or outdoors,
in-depth muscle toning and reinforcement,
in-depth muscle and joint suppleness workout,
increased protection against the risk of muscle, ligament or tendon injury,
enhanced effectiveness of the body's defenses,
improved blood circulation (vascularization).

The preferred choice of the temperature of 37° C. is based on the fact that this temperature, besides being the natural temperature of the human body, is the temperature at which, when combined with a humidity level of 50% to 60%, it is still possible to perform aerobic physical exercises and breathe in through the mouth or nose without experiencing excessive discomfort.

In this respect it must be noted that the humidity level is of paramount importance, since it allows a sufficient water content to be maintained in the air, so as not to dry out the pulmonary surfactant (therefore to maintain easy respiration) and to allow normal oxygen transfer into the blood.

As indicated above, the training room according to the invention is intended for one or more users. The training principle remains the same regardless of the number of users. A person skilled in the art will have the required knowledge to adapt the dimensions of the training room, as well as the number and power of the items of equipment, depending on the desired number of users.

The training room according to the invention is particularly intended for the following sectors:

The teaching of sports disciplines and leisure activities,

Health, wellbeing, fitness and weight loss,

Functional rehabilitation and post-traumatic or post-operative reathletization for athletes at beginner, experienced or expert levels (elite athletes).

For all these uses, the training room according to the invention can be equipped, for convenience, with one or more conventional items of sports equipment in the field, in particular one or more items of equipment for exercises, muscular development, rehabilitation and/or reathletization known to a person skilled in the art or the design of which is within his scope.

1-6. (canceled)

7. A method for enhancing effectiveness of exercise and training sessions to a human individual performing the exercise and training within an enclosed training environment, said method comprising the steps of establishing and maintaining the enclosed training environment at a temperature of at least 37° C. and a relative humidity in the range of 50 to 60%.

8. The method of claim 7, wherein the relative humidity is maintained at a level of 55%.

9. The method of claim 7, wherein the enclosed training environment is established and maintained at a temperature of 45 to 60° C.

10. The method of claim 9, wherein the relative humidity is maintained at a level of 55%.

11. A training gym facility comprising:
(a) an enclosed training room;
(b) at least one piece of exercise equipment disposed within the training room;
(c) an infrared heater and an associated thermostat, disposed within the training room and sufficient to heat the interior of the training room and maintain said interior of the training room at a temperature of at least 37° C.;
(d) a humidifier and an associated humidistat, disposed within the training room and sufficient to establish and maintain a relative humidity within the training room of 50 to 60%;
(e) a light fixture disposed within the enclosed training room; and
(f) a vent disposed to provide ventilation to the enclosed training room.

12. The training gym facility according to claim 11, wherein the enclosed training room has an interior floor, and said interior floor has a flexible and shock-absorbent covering.

13. The training gym facility according to claim 11, wherein the light fixture is a variable intensity light fixture.

14. The training gym facility according to claim 13, wherein the enclosed training room has an interior floor, and said interior floor has a flexible and shock-absorbent covering.

15. The training gym facility according to claim 11, further comprising an air ionizer disposed within the enclosed training room.

16. The training gym facility according to claim 15, wherein the enclosed training room has an interior floor, and said interior floor has a flexible and shock-absorbent covering.

17. The training gym facility according to the claim 17, wherein the light fixture is a variable intensity light fixture.

18. The training gym facility according to claim 17, wherein the enclosed training room has an interior floor, and said interior floor has a flexible and shock-absorbent covering.
